(19) United States
(12) Patent Application Publication
(10) Pub. No.: US 2002/0055981 A1
(43) Pub. Date: May 9, 2002

(54) System and method for remotely browsing structured data

(76) Inventors: Frederic Spaey, Linkebeek (BE); Marc-Henri Wouters, Brussels (BE)

Correspondence Address: Tyler S. Brown, Morrison & Foerster LLP, 2000 Pennsylvania Ave., N.W., Washington, DC, 20006-1888, US

(21) Appl. No.: 09/942,880

(22) Filed: Aug. 31, 2001

Related U.S. Application Data
(60) Provisional application No. 60/229,120, filed on Aug. 31, 2000.

(51) Int. Cl. G06F 15/16

(52) U.S. Cl. 709/217; 345/738

(57) ABSTRACT

A system and method to synchronously access structured data using the Internet platform (browser) to access, search, filter and sort remotely stored data. The system and method, called WebData viewer, includes three main parts: an interface, a communication protocol, and an intelligent server. The interface can be button driven interface, which is presented in a layered approach. The interface provides an API that can receive and call functions from outside allowing for tight integration with other web-based applications. The communication protocol uses a compressed format to maximize performance, and has a modular format to accommodate for independence between the interface and the intelligent server. The intelligent server's function is to provide the information the user requests via the interface by formatting the interface request for the database and formatting the results from the database for the interface.

### FIELD OF THE INVENTION

The present invention relates generally to a system and method for remotely browsing structured data combining the advantages of the Internet and standard client-server applications. More particularly, the present invention relates to a system and method for searching, visualizing, sorting, selecting and filtering structured data inside an Internet browser.

### BACKGROUND OF THE INVENTION

Looking at the state of the art of structured data browsing interfaces, we see either extremely specialized custom developed interfaces or functionally poor but easily accessible web interfaces.

The Internet Model:

The major characteristic of the Internet model is that the server handles data, processing and interface. There is low intelligence or processing on the front-end. The front-end merely displays the HTML document that contains the data and the formatting. In practice this means that the processing needs to happen asynchronously, one needs to fill a HTML form with data for example one or more search strings (see FIG. 1), sendit to the server and the return is a HTML document containing not only the results but also the complete interface formatting (see FIG. 2).

The Custom Application Model (Client-server):

Custom applications focus on delivering the ideal solution for a specific situation and/or environment. Many custom applications focus on data management, i.e. searching, visualizing, sorting, selecting, filtering and entering data. Each of them is specifically designed for the data it is accessing.

The common software architecture used is the client-server model.

Limitation of the Existing Models:

Both models have severe limitations.

The Internet model was originally intended to distribute and display media rich documents. Due to its widespread availability it has evolved towards a more complete application architecture platform but at the cost of severe functional limitations and an inefficient distribution of processing. Therefore this model requires highly available and broad communication channels to make the performance acceptable to the users and even then lacks the interactivity and rich functionality of more traditional client-server applications.

The Internet model was never intended to support rich interactive data browsing applications.

It has several drawbacks:

The user is not assisted with data entry, he needs to know the correct spelling and format of the data he is searching for;

The display of the results (data) cannot be manipulated locally (size and order of columns, selection, different views . . . );

The meta-data about the structure is lost. Meta-data is information about the data, i.e. information about the structure of the data, when it was last modified, who has access.

Performance is poor as not only result data but also the whole HTML page including the interface formatting and logic (local scripts) needs to be reloaded for every query.

The custom application model relies heavily on functions of the local operating system and therefore cannot easily be ported to new emerging devices. This architecture requires closed, controlled environments (Intranet) as the configuration of the different components is crucial.

The custom application model does not have the drawbacks inherent to the Internet model, but due to its reliance on a controlled front-end platform, it is unsuitable for widespread distribution and use.

It relies on client-side processing to process and display the data, which explains the reliance on a well-defined client environment.

Data communication is generally handled at the socket level, with a dedicated socket for the application. This leads to problems in open (Internet) environments, where proxies and firewalls control the communication.

The model cannot be installed in an open environment with multiple types of end-user platforms, nor can it be as intuitive as a generic more open and widespread format.

Furthermore the complex development, set-up and maintenance of this type of application make them extremely expensive to develop and run.

### SUMMARY OF THE INVENTION

The invention provides a system and method to synchronously access structured data using the Internet platform (browser) to access, search, filter and sort remotely stored data (see FIG. 3).

The invention provides a quantum leap in usability for the user similar to the move from dumb terminals to PC systems. This increased usability (performance, functionality and convenience) will make working with substantial amounts of structured data over the web convenient enough to replace existing, desktop based, and custom made applications. All of this while retaining the web most interesting features: no installation, very little maintenance, global accessibility and a flexible, pleasing, user-oriented design.

To obtain the same user acceptance and easy distribution characteristics than Internet search application, it is preferred that the invention be integrated into existing web pages. Seamless integration is preferred to avoid problems with firewalls, proxies and other environment specific settings. This has been achieved and distinguishes the invention from java and active X based solutions which suffer from the above-mentioned problems.

According to one embodiment of the invention, there is provided a data processing method for incrementally and automatically searching and displaying structured data through an Internet browser.

According to one aspect, the data processing method stores the displayed data on a remote server.

According to another aspect, the data processing includes combining a search on multiple columns of the search interface.

According to another aspect, the method includes reducing the list box to possible values according to the search restrictions imposed by searches in other columns.

According to another aspect, the data processing method includes selecting search values from a dropdown list box containing existing values for that column.

According to another aspect, the data processing method includes searching on each individual column of the search interface.

According to another aspect, the data processing includes sorting the result of the search.

According to another aspect, the data processing includes sorting search result on a specific column.

According to another aspect, the data processing method includes searching by using various search operators.

According to another aspect, the data processing method includes modifying the display column width.

According to another aspect, the data processing method includes displaying next or previous page search result.

According to another aspect, the data processing method includes displaying next or previous columns of search result.

According to another aspect, the data processing method includes selecting the table of the source database.

According to another aspect, the data processing method includes automatically refreshing the search result.

According to another aspect, the data processing method includes configuring a specific skin for the interface.

These and other advantages and features of the present invention will become readily apparent from the detailed description, which is to be read in conjunction with the accompanying drawings.

### DESCRIPTION OF THE DRAWINGS

FIG. 1 illustrates an example of classic data entry form on the Internet.

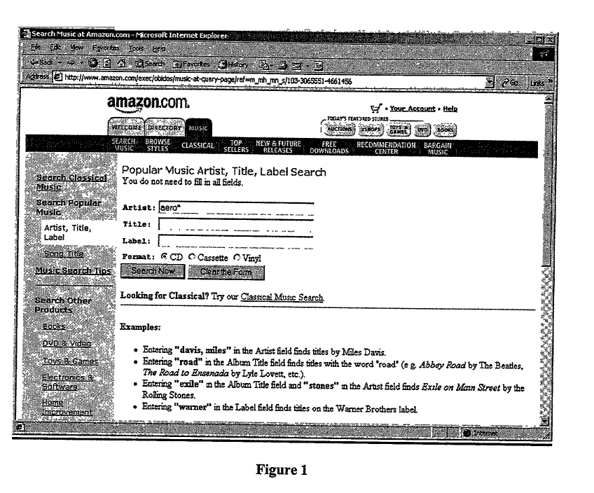

FIG. 2 illustrates an example of classic result form on the Internet.

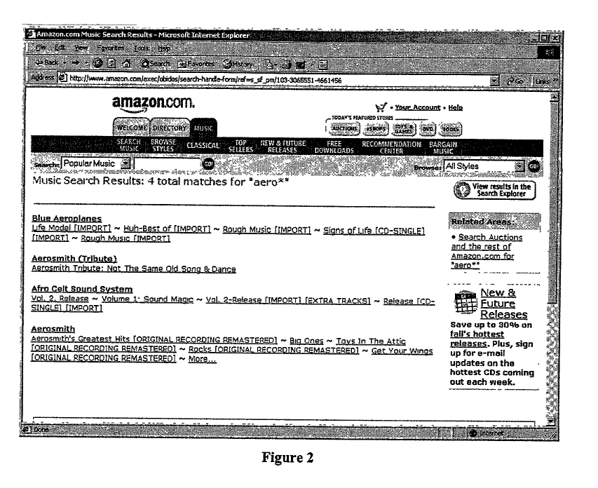

FIG. 3 illustrates the overview of the interface of the invention.

FIG. 4 illustrates the overview of the architecture of the invention.

FIG. 5 illustrates the modular design of the interface according to one embodiment of the invention.

FIG. 6A illustrates the dynamic adaptation of the display of the interface according to one embodiment of the invention.

FIG. 6B illustrates the dynamic adaptation of the display of the interface according to one embodiment of the invention.

FIG. 7A illustrates the dynamic dropdowns of the interface according to one embodiment of the invention.

FIG. 7B illustrates the dynamic dropdowns of the interface according to one embodiment of the invention.

FIG. 8A illustrates the incremental search process according to one embodiment of the invention.

FIG. 8B illustrates the incremental search process according to one embodiment of the invention.

FIG. 8C illustrates the incremental search process according to one embodiment of the invention.

FIG. 9 illustrates the real-time search process on multiple columns according to one embodiment of the invention.

FIG. 10 illustrates the skin structure of the interface according to one embodiment of the invention.

FIG. 11 illustrates the code structure of the interface according to one embodiment of the invention.

FIG. 12 illustrates an example of cascading function calls according to one embodiment of the invention.

FIG. 13 illustrates the protocol structure of the data browsed according to one embodiment of the invention.

### DETAILED DESCRIPTION OF PREFERRED EMBODIMENTS OF THE INVENTION

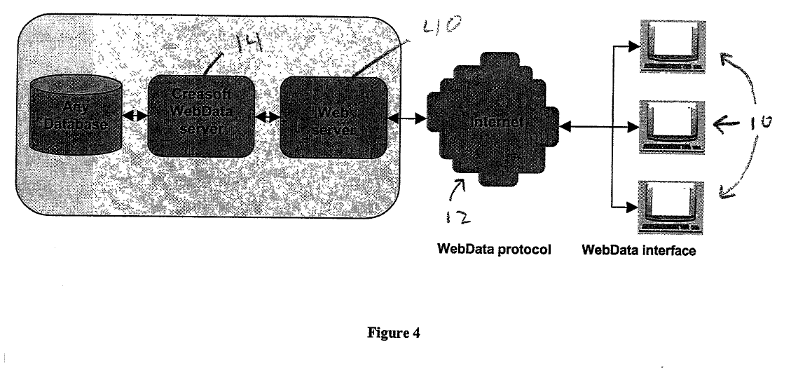

According to one preferred embodiment, the invention, called WebData viewer, includes three main parts: the interface 10, the communication protocol 12 and the intelligent server 14 (see FIG. 4). The following is an overview of those three parts.

The Interface 10:

The interface 10 is button driven, i.e. all actions are activated by pressing buttons in opposition to menu or command line driven interfaces. It has rich functionality, which is presented in a layered approach:

The main functions are intuitive and can be used without prior knowledge of the application.

The more complex and advanced features are not as present on the interface to make sure the normal user is not overloaded, while still guaranteeing the necessary tools for more complex searches by expert users.

It is extremely small, does not require any installation and is designed to specifically take advantage of the caching function of existing browsers. Once the interface is downloaded, only the displayed records are transferred from the server, not the entire results of the search query.

The use of Internet standard (HTML) guaranties cross-platform compatibility and availability. Current browsers and operating systems in use on the Internet are fully supported.

The interface 10 is entirely dynamic, allowing the same code to be used to access different data sources. The display adapts the number of columns and column names at run-time. It is also multi-lingual adapting the name of the columns depending on the user's language.

It allows personification, saving user specific settings (e.g. column width) locally.

The interface 10 provides an API that can receive and call functions from outside allowing for tight integration with other web-based applications.

Furthermore the interface 10 is designed to be integrated into HTML pages both technically (detailed below) and graphically. It has a modular design and can easily be adapted to suit different situations by adding or removing different functionality. The code is divided in two distinct files to allow the graphical design to be modified independently.

The combination of the features mentioned above has several key advantages:

Full applicative functionality: The button driven interface described above provides a level of functionality and comfort significantly better than what is currently available today on the Internet. It combines the advantages of custom developed, client server application with the intuitiveness and simplicity of Internet web pages.

Performance: The intelligent use of the browser's cache and the limited data transferred for each query significantly improve the user perceived performance compared to current Internet search interfaces.

Easy distribution and maintenance: The fact that the invention runs as part of a HTML page, uses HTTP, is extremely small and does not require any installation is a key advantage compared to the cumbersome distribution and maintenance of custom developed, client server data applications.

Look and feel is completely modular and dynamic:

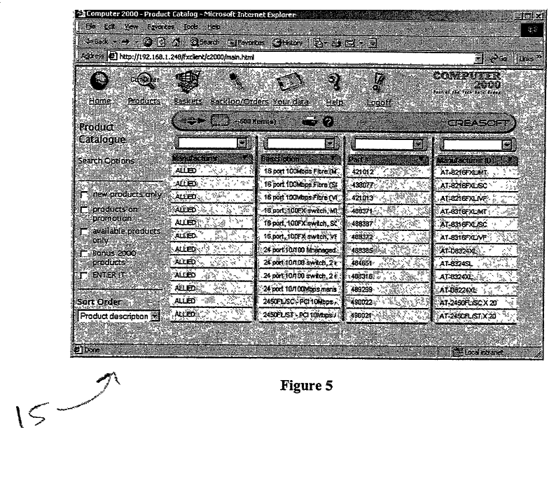

This is a major advantage compared to custom developed, client server data applications 15 (see FIG. 5).

The Protocol 12:

The WebData protocol 12 uses the standard HTTP(S) protocol as a carrier for the information. This allows the application to work transparently across firewalls and proxies, which forms today's Internet infrastructure.

The protocol 12 uses a compressed format to maximize performance.

The protocol 12 has a modular format to accommodate for independence between the interface and the intelligent server. This means that different versions of the protocol can run simultaneously with the same intelligent server 14.

The characteristics of the protocol 12 mentioned above have the following advantages:

Ease of use in open (Internet) environment:

The use of the standard HTTP or HTTPS protocol and ports to communicate with the server and the modular format allow easy distribution use and maintenance across the Internet. The protocol can be adapted to regional use of special characters without the need for a specific dedicated server. A major advantage compared to custom developed, client server data applications 15.

Performance: The compact protocol guarantees adequate performance even across low-bandwidth connections typical of the Internet. It is far more efficient then standard Internet search applications that send uncompressed HTML pages across the network.

The Intelligent Server 14:

The server's 14 function is to provide the information the user requests via the interface by formatting the interface request for the database and formatting the results from the database for the interface.

In concordance to the general design of the interface 10, the server 14 only returns the data that needs to be displayed in the interface 10.

The server 14 is sessionless, i.e. no information about past requests is required to process the current request. This means several servers can process incoming requests in parallel.

The server 14 has been developed with a web-based configuration interface allowing remote management.

To support the interface functionality, the server 14 can handle data filtering, adapting the view according to a pre-set user profile. This profile can also contain personification information and allow multi-language support as mentioned above.

The server 14 is integrated with the security features of classic web-servers: authentication, encryption and certificates.

The above-mentioned characteristics have the following advantages:

Scalability: Adhering to a session-less model allows for unlimited scalability by increasing the number of parallel servers servicing the requests.

Cost: The above-mentioned setup does not require “intelligent”, session aware load balancing to work. This increases the execution architecture choices and reduces cost. Furthermore the web-based configuration interface simplifies configuration and maintenance further decreasing cost of ownership compared to custom developed client-server applications.

Performance: The scalable architecture and intelligent reduction of data transferred allow for significantly better performance (factor 5-10) than existing Internet search applications.

To realize the quantum leap in usability, performance, comfort and easy distribution on the Internet of this invention, the standard distribution of processing is revisited. The present invention takes a novel approach, which is detailed below.

To allow for an easily distributed, but still functionally rich interface a middle way between classic Internet applications without any local processing and custom developed client-server applications with substantial local processing and logic is needed. In a preferred embodiment, the graphical aspects are concentrated in the interface 10 but the server 14 executes all the processing. Every time a button is pressed a request goes out to the server 14. This allows the use of a graphical environment, for example Macromedia Flash, to develop the interface 10, which in-turn guaranties cross-platform compatibility and seamless integration with existing web pages. The exact distribution of processing is detailed below.

Performance in an open, often low-bandwidth environment like the Internet is a key factor for user satisfaction. Performance considerations have been the major driver of the present invention. This has repercussions on all aspects of the application and has led to a method where only the requested, visible data is transferred between the server 14 and interface 10.

The graphical objects of the interface 10 are transferred.

On request only the visible data (no formatting information) is transferred and not the complete results of the query. Subsequent pages (scroll down) trigger new request.

The content of the lists (drop-down boxes, list boxes, . . . ) is dynamically loaded from the server 14 on request.

Another crucial element of this preferred embodiment is the hierarchical object-oriented model it is based on. This allows great transfer efficiency as well as easy multi-user management.

The Interface 10:

The aim was to design a data browsing interface that would be as functional as a client-server application and as easy to use and distribute as an Internet web page.

HTML Based

The interface 10 is a Macromedia Flash object and can be embedded into any web page using the HTML Tag <OBJECT>.

Modular

The interface 10 has been separated into two files:

The main one, called CODE 16 contains the structure of the movie, and the functionalities, but no graphical objects.

The second one called SKIN 18 contains the “look” of the interface 10. It is dynamically loaded by the CODE 16 at execution.

The split allows improved modularity, adapting the look and feel of the application to the needs of the particular website it resides on. This is an important feature for Internet applications and something not achieved in the past.

But more particularly, this splitting allows one to modify a simple graphical file without the need and risk to modify the underlying code. It also allows one to compile the skin 18 separately from the code 16 and vice-versa.

The two architectures are Object Oriented and very similar, the skin 18 respecting the architecture of the visible elements referenced in the code 16.

Skin 18

The skin 18 has the same object structure as the code 16, but it is important to understand that the skin 18 only contains visible elements, it has no functionality.

For instance: in our application, a button has 3 parts: the drawing, the effect it has when clicked or rolled over, and the action done on click or roll over, In the code 16, there are only the actions, and there are references to drawings and effects. That induces that the skin 18 must have the same structure as the code 16.

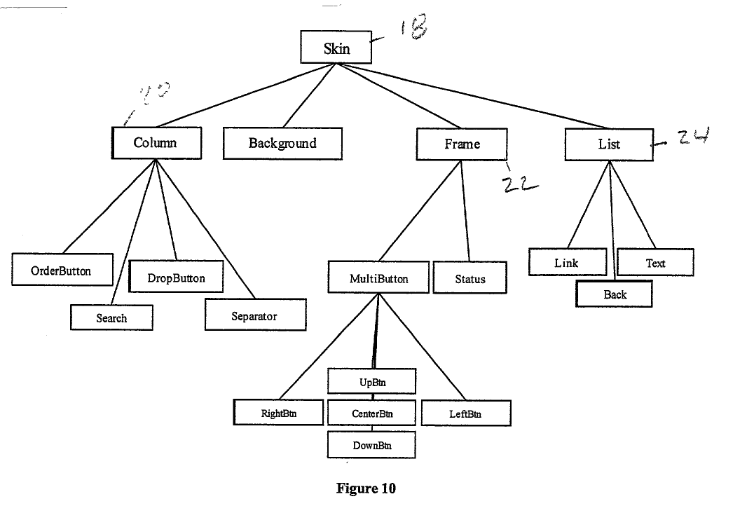

All the display components can be found in the skin 18: columns 20, frame 22, the list element 24, and all their sub objects (see FIG. 10).

All modification to the appearance of the application can easily be done modifying the graphical properties of the skin 18 as long as the structure and naming conventions are respected.

Code 16

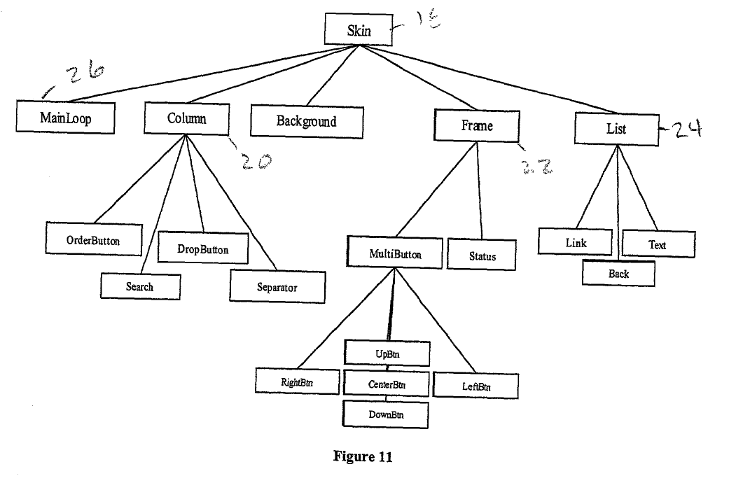

Logically the code 16 and the skin 18 have similar object structures, as one contains the code 16 and the other contains the appearance of the same objects (see FIG. 11). The main differences are:

The skin 18 is a part of the code 16 (the skin 18 is loaded as an external Flash Movie from the code 16).

The code 16 contains no visual part of objects, only references to visual parts, which are in the skin 18.

The code 16 contains all functions related to an object.

It contains some more objects that are not in the skin 18. The reason is that they are not meant to be displayed, they just contain code 16.

Dynamic

In both the structure of the skin 18 and the code 16, there is only one object of every type, for example column 20. On the other hand when the application is running, there can be more than one instance of an object (column 20). The used technique is to duplicate the object dynamically at run time.

This has many advantages:

One can have as many columns 20 displayed as needed: there is no “hardcoded” limit.

It greatly reduces the time to download the component. Again an important performance consideration for an Internet based application.

As far as Macromedia Flash is concerned, it is much more efficient, because at run time the management of memory is better with duplicated objects then with identical objects with different names.

This technique is used for all objects and is crucial to obtain the level of dynamic behavior required to adapt to different situations and offer the rich functionality that set this invention apart from traditional HTML based Internet applications.

On duplication, we give another instance name to the duplicated object, to differentiate them.

Now follows a detailed description of the initialization of the interface 10 to explain how the above-mentioned design has been implemented:

The main object of the interface is called “main loop” 26. This is the object that controls the interface 10 and triggers the other objects when required.

It begins by executing the start command. “Start” 28 and does all the initialization of the display:

It searches for the remote parameters (given from outside the Flash Movie: JavaScript embedded in an HTML document for instance).

It calls the “init” 30 function of the top-level object in the hierarchy.

“Init” 30 takes all initializing parameters given from inside the Flash Movie.

It initializes all the properties of the main object before duplicating the objects it contains and calling their “init” functions 30. This cascade goes further until all objects have been duplicated and initialized.

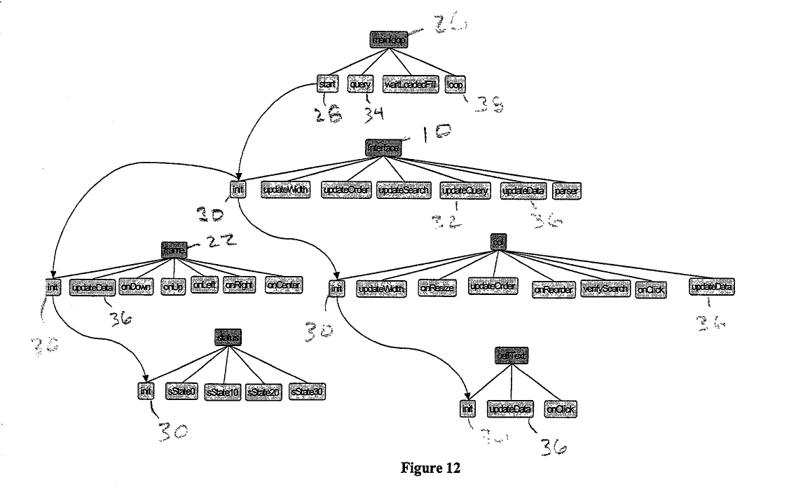

This “init” cascade is shown in the FIG. 12.

This object-oriented methodology is applied to all functions. It is the base for efficiency, flexibility and rich functionality that characterize the invention.

The first search is called by the init function. This first search is special in that it incorporates a behavior by default. All variables, which have not been set by the start function 28(see above), are set to pre-defined default values that are recognized by the server 14 and trigger the server 14 to use values defined in his initialization file. Typically these are database name, table name, and column width. This further increases the dynamic behavior of the interface 10.

Intelligent Redistribution of the Processing Between Client and Server

The reason the interface 10 does not have the weaknesses of traditional client-server and java applications is that it is only graphical. There is no local manipulation of the data, which greatly simplifies the demands towards the client environment and allows the use of a purely graphical tool as Macromedia Flash.

This set-up implies untraditional function architecture to cope with the limited possibilities of the Macromedia Flash environment and achieve outstanding performance. The interface 10 focuses on the graphic elements like resizing and scrolling records. These actions are executed locally. For the rest the interface 10 just formats a query to the server 14 depending on the user input and displays the result. The server 14 formats and sorts the results, so that the interface 10 can display them as is. No local transformations are performed and only the displayed records are transmitted. This increases performance and further decreases the complexity of the interface 10.

This is true throughout the interface 10:

For scrolling

For sorting

For the drop-downs

Now follows a detailed description of the main function that builds the query to the server 14.

This function can be called from different objects. It is first called at the end of the init 30 function to fill the display with the default data. After that it is called by either:

The “main loop” 26 which watches for changes in the search boxes

The dropdown buttons, when an entry is selected

The reset button, to reset the display to the default data

The reorder button to change sorting

The page up and page down buttons

There are 3 phases:

Update query 32: this function gathers all the information required to build the query 34. It assembles the query strings from all the search boxes and defines on which column the results should be sorted.

Query 34: This function of the “main loop” 26 handles the communication with the server 14. It submits the query 34 to the server 14 and waits for the server's 14 reply;

Update data 36: The Updating of data follows a “cascade” technique, which is also used for the initialization of the interface 10: The “main loop” 26 calls the “UpdateData” 36 function from the code object, which calls the UpdateData 36 function of all its sub objects, and finally, every item has used the variables set by the response of the server 14 to update its display variables.

Once this function is through, the MainLoop 26 re-enters the “loop” 38 function. This is the daemon that waits for user input in the search boxes.

Button Driven

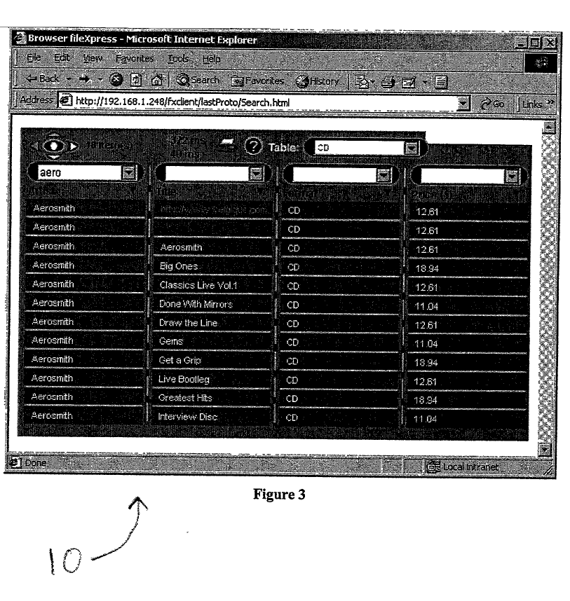

To design a simple and intuitive, yet functionally rich interface 10 we chose a mainly button driven interface. Each main function (sort, scroll, print, clear display . . . ) has an associated button. Each button stands out as a three-dimensional object on an otherwise two-dimensional interface (see FIG. 3). User-labs have shown that this is the most intuitive interface for use on the Internet.

Layered Functionality

To further increase the functionality without reducing the simplicity and intuitiveness the invention has a layered approach. As mentioned above obvious buttons handles the main functions. The suppler and less used features are triggered by suppler and less visible objects.

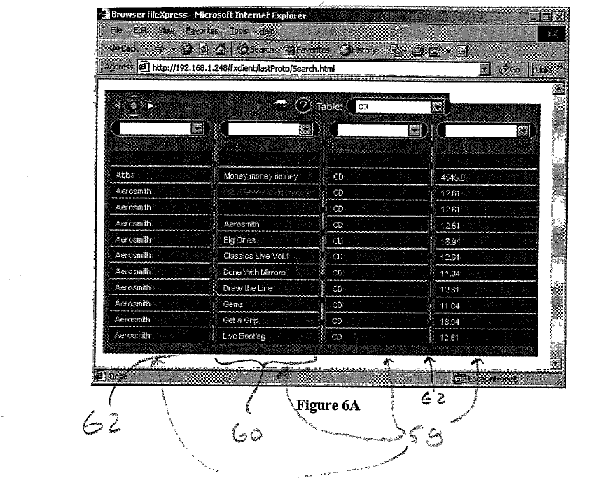

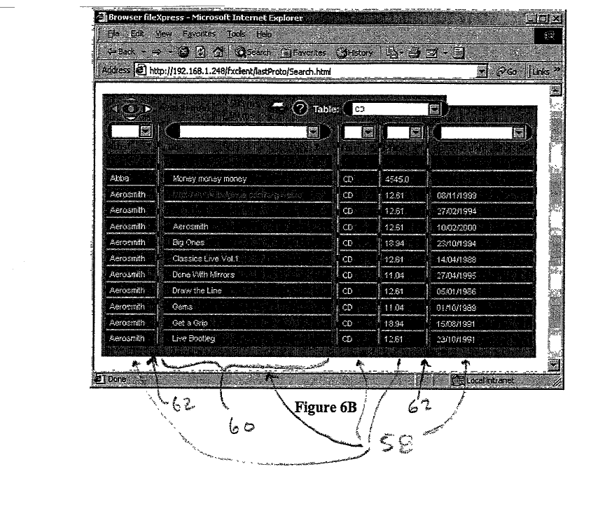

The display can adapt itself dynamically, modifying the number of columns 58 and column width 60 (see FIGS. 6A & 6B). This is done by dragging the column separator 62.

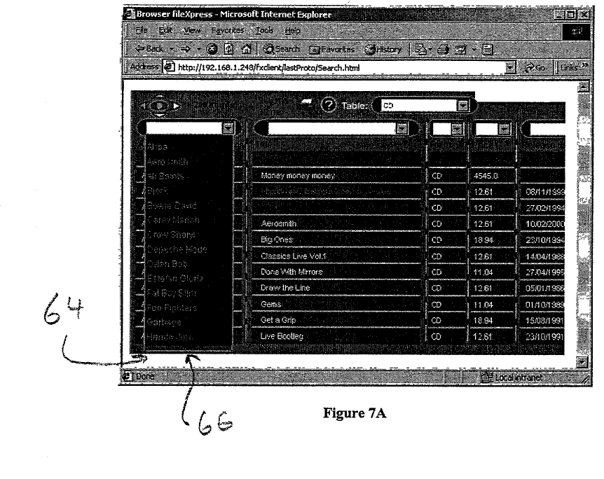

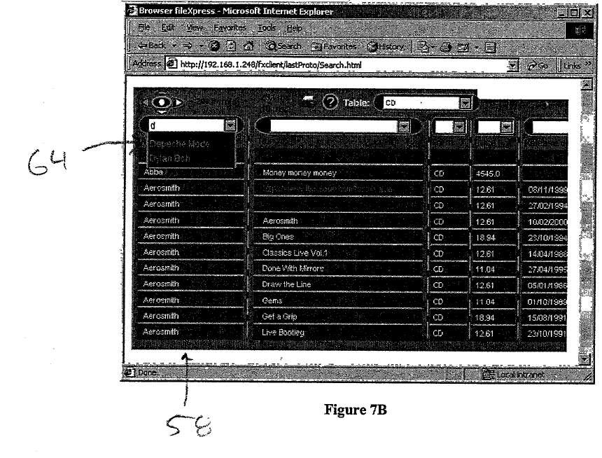

Dynamic dropdowns 64 help the user whenever necessary and are populated dynamically depending on the context. This selection is dynamically generated depending on the search criteria entered in the search columns as well as the result of searches in other columns. This means that at any given time the dropdown 64 will only offer valid search strings. If there is more then one page of items then scroll buttons 66 appear (see FIGS. 7A & 7B).

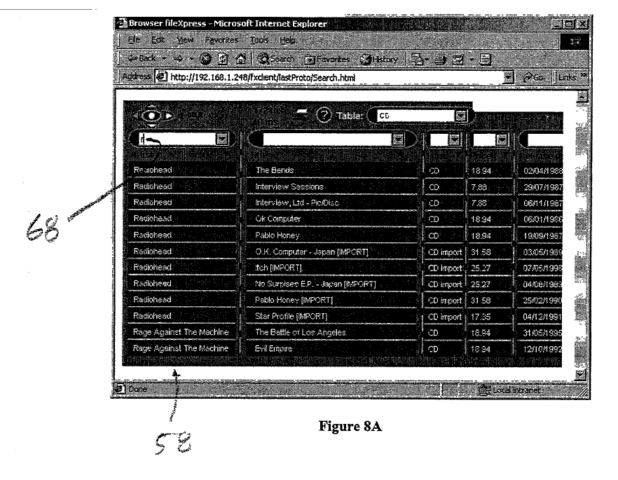

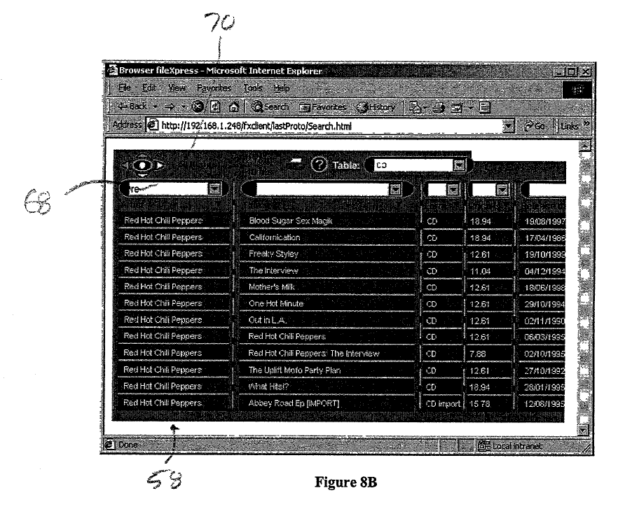

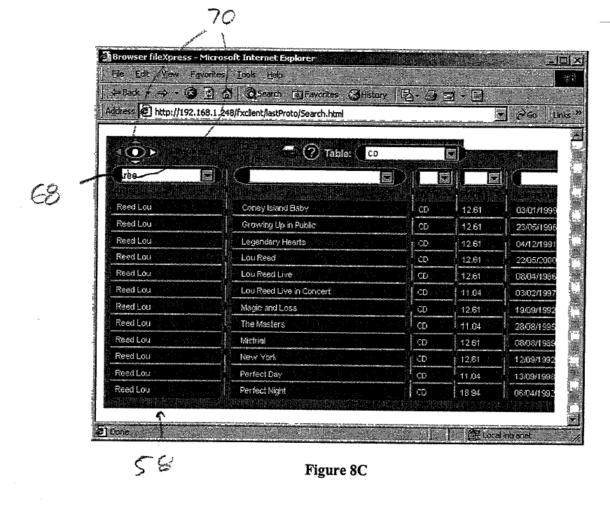

Incremental search, i.e. the search process on the server 14 is triggered as soon as a character 68 is typed and narrows down synchronously with each additional character 70(see FIGS. 8A, 8B & 8C).

The invention allows searching on all columns 58.

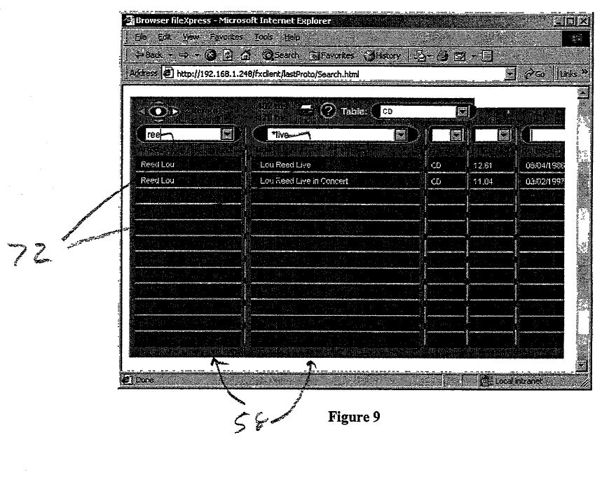

It allows searching on a combination of columns 58 (see FIG. 9). Search criteria 72 on multiple columns 58 are combined to create a more restrictive result set.

Result data can be sorted on any column (up and down). Classical alpha-numerical order is applied on all the values of the sorted column 58.

It allows advanced searches using logical combinations and wildcards:

Or +

Less −

Equal or less then <

Equal or more then >

And&

Empty#

Scan*

Full table scan **

All other operators supported by database engines (near, like . . . ).

The Result set is presented as a list of record, one record per line. Multiple pages of the result set can be accessed with page down/page up buttons. If some columns 58 can't be displayed inside the browser frame, column left/right buttons give access to hidden columns.

Other data tables from the same data source can be accessed from the invention interface 10, through a drop down list box.

Other features include, help function, configuration panel, choice of color and font.

Extra Small

Small size is critical as the interface 10 is downloaded every time the user requests the web page. It has been achieved by:

Using vector graphics for all graphical objects;

By using a dynamic, object oriented interface, were objects are downloaded only once and duplicated at run-time. A shape is only drawn once and shared by all buttons (see Dynamic);

Reducing the amount of logic to a minimum (see Intelligent redistribution of the processing between client and server 14).

WebData Protocol 12:

As said before, it defines the communication between the WebData Interface 10 and the WebData Server 14 through the Internet.

Use of Standards

The protocol 12 is encapsulated in the HTTP protocol; it uses the port 80 (standard) of the web server 40. This port is available on ALL web servers 40. This guarantees that the Web Data Protocol 12 and therefore the whole WebData Viewer can be used easily, without specific software or hardware. It also guarantees that the WebData Viewer will work across firewalls and proxies and without any specific constraints on the client, the server and any part of the network in between.

The use of the HTTP protocol implies that the message needs to be “text”. The message is coded in MIME; which is similar to ASCII.

The Web Server 40 intercepts the message and passes it over to the WebData Server 14 using an ISAPI filter that interprets the message header.

The reply to the browser uses the same mechanism.

Object-oriented

It uses the hierarchical, Object-Oriented structure of the data at the base of the application (Business data).

That's one of the basic ideas of this protocol: to use the different levels in the structure of the data browsed.

The business data has a structure; the interface 14 needs a part of this structure. Using the protocol 12, it will define the sub-structure it needs precisely, and the server 14 will reply by sending object-oriented variables containing the sub-structure requested.

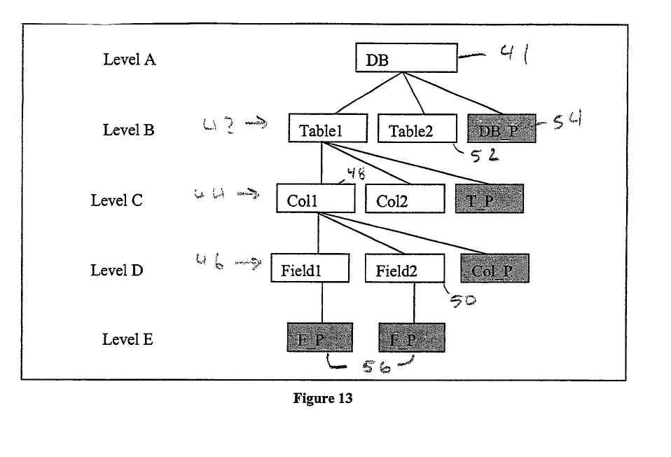

For instance, we'll consider a database 41 with tables 42, columns 44 and fields 46(see FIG. 13).

The databases 41 are the first level: let's say A; the tables 42 are the second level: let's say B, etc.

The data is structured as a tree. Each node (in white on FIG. 13) can have:

One or more sub-trees

One or more properties (here in gray) that contain an attribute of the father node.

The protocol 12 has 2 functionalities: to set and to get properties of objects (nodes).

This allows the client to define input parameters (variables set) and an output structure (variables get) as required to fill the visible part of the interface 10.

Another important feature of this protocol 12 is that one can navigate the tree: from the top level to Coll 48 and further to Field2 50 to get one of its attributes, then back to Table2 52 to get its name attribute. This allows all the necessary flexibility the interface 10 needs to define its requirements. The protocol 12 is generic enough to handle future functions of the interface 10 without modifying its inherent structure.

You will find detailed explanations of the components of this request and the answer in the next sections.

The properties have already been described in the previous sections, but it is important to notice that the properties of an object (the node of a sub tree) are in the first level under the node. A property is always a leaf of the sub tree.

For instance the properties of the database 54(represented by the gray rectangle named DB_P 54 on the FIG. 13) are part of the Level B, they are below the “Database Level”, at the “Tables Level”. Theses properties are for instance its name, number of columns, etc.

You have the same principle for every other level, except the last level (in the figure level E), which contains no sub-structure, only the properties 56 of the Level D elements: here the fields 46.

The purpose of the “default element” is to allow the client to ask for data it doesn't know. This is typically used in the initial request to the server 14 as described in the interface 10 section above.

The protocol 12 has defined special characters to identify default elements.

The handling of default values will be discussed in further details in the WebData server 14 section.

The fact that the special characters are defined in the protocol 12 and sent with every request allows clients with different configurations, for example geographical differences in the use of character sets to talk to the same server. This is very important for broadly distributed Internet based applications.

A full description of all the elements of the WebData protocol 12 can be found in the annex.

Performance

The format has been optimized for message size and easy handling by the WebData Interface 10.

The WebData Server 14:

The WebData server 14 is a thin layer of code, which handles:

The communication with the interface 10;

The default behavior at initialization;

The query to the database and its results.

From an architecture point of view it is very similar to a traditional web server. It is session less to allow for load balancing and keep the overhead small keeping with the web server architecture.

The Communication with the Interface 10

The server uses an ISAPI Filter to filter out the WebData interface 10 messages. This filter is multithreaded, creating a thread for each simultaneous request. Then the message is parsed, creating a request for every “get” (see above) request it gets. It immediately starts to build the reply string by concatenating the results of the queries using the variable definitions defined in the protocol 12 (see protocol). Once it gets to the end of the message it sends the reply string back to the server 14 using the same protocol 12.

The Default Behavior at Initialization

The server 14 can handle default values in two ways:

The value is defined in the initialization file (for example the name of the default database).

The server 14 can deduce the correct information from the message. For example a range of columns 1-10 will return the first ten columns of the table.

This mechanism is used principally at initialization and allows great flexibility because either the default values are used or one can set specific values in the web browser or cookie to personalize the initialization.

The Query to the Database and its Results

The server 14 queries the database and handles the result set returned by the database.

The database API must be able to handle the kind of query required, including operators:

AND

OR

=

BEGIN WITH

CONTAINS

SMALLER/GREATER THAN

. . .

Any database API can be used (SQL, ODBC, Oracle).

Multiple simultaneous queries are handled by shared database access.

A database access pool is available for the user request. Each user request is assigned to an available database access. If there is no more database access available, the request is put on hold until a database access is freed. Multiple requests from the same user are queued on the same database access. This allows better performances (cache optimization).

No specific session information is kept. In a multiple server configuration, an user request is answered by any server, allowing greater scalability.

The result size is limited to the display size needed for the user (one page). The following pages are fetched with new separate user queries. The query also specifies the field to fetch.

Although certain presently preferred embodiments and examples of the present invention have been specifically described herein, it will be apparent to those skilled in the art to which the invention pertains that variations and modifications of the various embodiments and examples shown and described herein may be made with departing from the spirit and scope of the invention.

What is claimed is:

1. A data processing method comprising:
incrementally searching structured data based on a search request; and
displaying a search result of the searched structured data based on the search request through an Internet browser.

2. The data processing method of claim 1, further comprising storing the displayed search result on a remote server.

3. The data processing method of claim 2, further comprising combining a search on multiple columns of a search interface.

4. The data processing method of claim 3, further comprising reducing a list box for a column to possible values based on search restrictions imposed by searches in other columns.

5. The data processing method of claim 2, further comprising selecting search values from a dropdown list box for a column containing existing values for the column.

6. The data processing method of claim 5, further comprising reducing the dropdown list box for the column to possible values based on the search restrictions imposed by searches in other columns.

7. The data processing method of claim 1, further comprising searching on each individual column of a search interface.

8. The data processing method of claim 1, further comprising sorting the search result.

9. The data processing method of claim 8, further comprising sorting the search result based on a specific column.

10. The data processing method of claim 1, further comprising searching using search operators.

11. The data processing method of claim 1, further comprising modifying a display column width.

12. The data processing method of claim 1, further comprising displaying a next or previous page search result.

13. The data processing method of claim 1, further comprising displaying next or previous columns of a search result.

14. The data processing method of claim 1, further comprising selecting a table of a source database.

15. The data processing method of claim 1, further comprising automatically refreshing the search result.

16. The data processing method of claim 1, further comprising configuring a specific skin for an interface.
